(19) United States
(12) Patent Application Publication
(10) Pub. No.: US 2025/0237223 A1
(43) Pub. Date: Jul. 24, 2025

(54) MOTOR-DRIVEN COMPRESSOR

(71) Applicant: KABUSHIKI KAISHA TOYOTA JIDOSHOKKI, Kariya-shi (JP)

(72) Inventors: Yumin HISHINUMA, Kariya-shi (JP); Shiro HAYASHI, Kariya-shi (JP)

(73) Assignee: KABUSHIKI KAISHA TOYOTA JIDOSHOKKI, Kariya-shi (JP)

(21) Appl. No.: 18/987,066

(22) Filed: Dec. 19, 2024

(30) Foreign Application Priority Data
Jan. 18, 2024 (JP) 2024-005939

(51) Int. Cl. F04D 25/06; H01R 13/52

(52) U.S. Cl. CPC F04D 25/0693; H01R 13/5202; H01R 2201/00

(57) ABSTRACT

A motor-driven compressor includes a housing that defines a motor chamber and an inverter chamber. The housing includes a partition wall that separates the motor chamber from the inverter chamber. A hermetic terminal includes a conductive member that passes through a through-hole. The conductive member has a first end electrically connected to an inverter and a second end electrically connected to a connection terminal. The hermetic terminal also includes a support plate fixed to the partition wall while supporting the conductive member and blocking the through-hole. The cluster block includes a conductive member insertion hole through which the second end of the conductive member is inserted. The support plate is fixed to the partition wall while being arranged in the motor chamber. A periphery of the conductive member insertion hole in the cluster block includes a seal surface that makes surface contact with the support plate.

### CROSS-REFERENCE TO RELATED APPLICATIONS

This application is based upon and claims the benefit of priority from Japanese Patent Application No. 2024-005939, filed on Jan. 18, 2024, the entire contents of which are incorporated herein by reference.

### BACKGROUND

### 1. Field

The present disclosure relates to a motor-driven compressor.

### 2. Description of Related Art

Motor-driven compressors include a compression unit, a motor, an inverter, and a housing. The compression unit compresses fluid. The motor drives the compression unit. The inverter drives the motor. The housing defines a motor chamber and an inverter chamber. The motor chamber accommodates the motor. Fluid is drawn into the motor chamber. The inverter chamber accommodates the inverter. The housing includes a partition wall that separates the motor chamber from the inverter chamber. The partition wall has a through-hole.

The motor-driven compressor includes a hermetic terminal and a cluster block. The hermetic terminal electrically connects the motor to the inverter while providing a seal between the motor chamber and the inverter chamber. The cluster block is located in the motor chamber. The cluster block is insulating. The cluster block accommodates connection terminals. The connection terminals electrically connect the hermetic terminal to motor wires drawn out of the motor.

Japanese Laid-Open Patent Publication No. 2016-211490 discloses an example in which the hermetic terminal includes a conductive member and a support plate. The conductive member has a first end and a second end, and passes through the through-hole of the partition wall. The first end of the conductive member is electrically connected to the inverter, and the second end of the conductive member is electrically connected to the connection terminal. The support plate supports the conductive member. The support plate is fixed to the partition wall while blocking the through-hole of the partition wall. In the above-described publication, the support plate is fixed to the partition wall while being located in the inverter chamber.

In such a motor-driven compressor, the pressure of fluid drawn into the motor chamber acts on the support plate through the through-hole. Thus, the rigidity of the support plate may be increased by increasing the thickness of the support plate such that, for example, the support plate can withstand the pressure of the fluid. In this case, if the support plate is fixed to the partition wall while being located in the inverter chamber as described in the above-described publication, its increased thickness may cause the support plate to interfere with the inverter. Thus, to prevent the inverter from interfering with the support plate, additional space for the inverter needs to be created in the inverter chamber. As a result, the size of the motor-driven compressor increases.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A motor-driven compressor according to an aspect of the present disclosure includes a compression unit configured to compress fluid, a motor configured to drive the compression unit, an inverter configured to drive the motor, and a housing that defines a motor chamber which accommodates the motor and into which fluid is drawn, and defines an inverter chamber that accommodates the inverter. The housing includes a partition wall that separates the motor chamber from the inverter chamber. The motor-driven compressor also includes a hermetic terminal that electrically connects the motor to the inverter while providing a seal between the motor chamber and the inverter chamber, a connection terminal that electrically connects the hermetic terminal to a motor wire drawn out of the motor, and an insulating cluster block located in the motor chamber. The cluster block accommodates the connection terminal. The partition wall includes a through-hole. The hermetic terminal includes a conductive member that passes through the through-hole. The conductive member has a first end electrically connected to the inverter and a second end electrically connected to the connection terminal. The hermetic terminal also includes a support plate fixed to the partition wall while supporting the conductive member and blocking the through-hole. The cluster block includes a conductive member insertion hole through which the second end of the conductive member is inserted. The support plate is fixed to the partition wall while being arranged in the motor chamber. A periphery of the conductive member insertion hole in the cluster block includes a seal surface that makes surface contact with the support plate.

Other features and aspects will be apparent from the following detailed description, the drawings, and the claims.

### BRIEF DESCRIPTION OF THE DRAWINGS

FIG. 1 is a cross-sectional view of a motor-driven compressor according to an embodiment.

FIG. 2 is an enlarged cross-sectional view illustrating part of the motor-driven compressor shown in FIG. 1.

FIG. 3 is an exploded perspective view illustrating the hermetic terminal and the cluster block of the motor-driven compressor shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

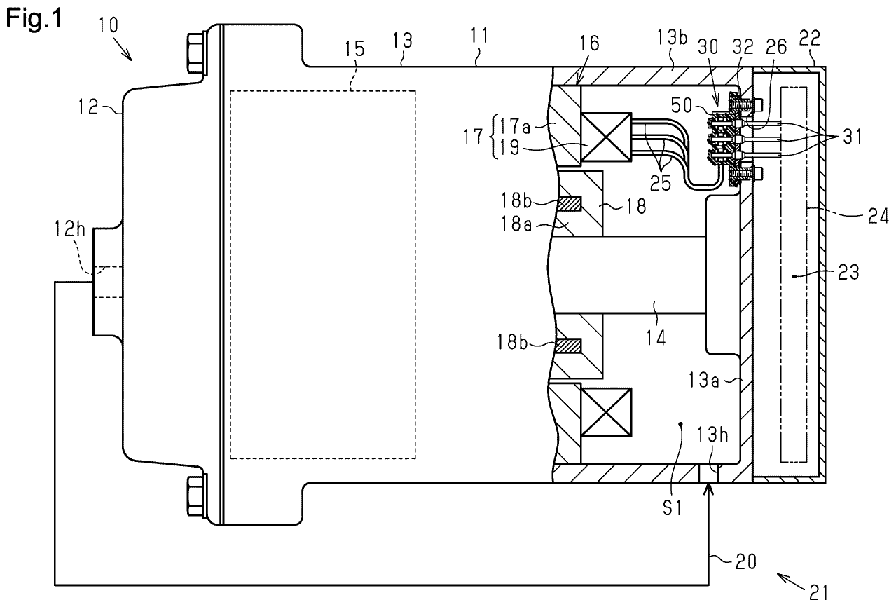

A motor-driven compressor according to an embodiment will now be described with reference to FIGS. 1 to 3. The motor-driven compressor of the present embodiment is employed in, for example, a vehicle air conditioner.

### Overview of Motor-Driven Compressor

As shown in FIG. 1, the motor-driven compressor 10 includes a housing 11. The housing 11 includes a discharge housing member 12 and a motor housing member 13. The discharge housing member 12 and the motor housing member 13 are tubular. The motor housing member 13 is coupled to the discharge housing member 12. The discharge housing member 12 and the motor housing member 13 are made of metal. The discharge housing member 12 and the motor housing member 13 are made of, for example, aluminum. The motor housing member 13 includes a plate-shaped end wall 13a and a tubular circumferential wall 13b. The circumferential wall 13b extends from an outer circumferential portion of the end wall 13a.

The motor-driven compressor 10 includes a rotary shaft 14. The rotary shaft 14 is accommodated in the motor housing member 13. Thus, the rotary shaft 14 is accommodated in the housing 11. The rotary shaft 14 is rotationally supported by the motor housing member 13.

The motor-driven compressor 10 includes a compression unit 15 and a motor 16. The compression unit 15 and the motor 16 are accommodated in the motor housing member 13. Thus, the housing 11 accommodates the compression unit 15 and the motor 16. The compression unit 15 and the motor 16 are arranged in an axial direction of the rotary shaft 14, in which a rotational axis of the rotary shaft 14 extends. The motor 16 is located closer to the end wall 13a of the motor housing member 13 than the compression unit 15. The space in the motor housing member 13 located closer to the end wall 13a of the motor housing member 13 than the compression unit 15 is a motor chamber S1, which accommodates the motor 16. Thus, the housing 11 defines the motor chamber S1.

Rotation of the rotary shaft 14 drives the compression unit 15. The compression unit 15 compresses refrigerant, which is fluid. The compression unit 15 is, for example, of a scroll type that includes a fixed scroll (not shown) fixed in the motor housing member 13 and an orbiting scroll (not shown) opposed to the fixed scroll.

The motor 16 includes a tubular stator 17 and a tubular rotor 18. The rotor 18 is located on the inner side of the stator 17. The rotor 18 is configured to rotate integrally with the rotary shaft 14. The rotor 18 includes a rotor core 18a and permanent magnets 18b. The rotor core 18a is fixed to the rotary shaft 14. The permanent magnets 18b are arranged in the rotor core 18a. The stator 17 surrounds the rotor 18. The stator 17 includes a tubular stator core 17a and a motor coil 19. The motor coil 19 is wound around the stator core 17a. When power is supplied to the motor coil 19, the rotor 18 rotates integrally with the rotary shaft 14. The compression unit 15 is driven by rotation of the rotary shaft 14. In this manner, the motor 16 drives the compression unit 15.

The housing 11 includes a suction port 13h. The suction port 13h is located in a section of the circumferential wall 13b of the motor housing member 13 closer to the end wall 13a. The suction port 13h draws refrigerant into the motor chamber S1. Thus, refrigerant is drawn into the motor chamber S1. The suction port 13h is connected to a first end of an external refrigerant circuit 20. The housing 11 includes a discharge port 12h. The discharge port 12h is formed in the discharge housing member 12. The discharge port 12h is connected to a second end of the external refrigerant circuit 20.

Refrigerant that has been drawn into the motor chamber S1 from the first end of the external refrigerant circuit 20 through the suction port 13h is compressed by the compression unit 15 when the compression unit 15 operates. The refrigerant compressed by the compression unit 15 flows to the second end of the external refrigerant circuit 20 through the discharge port 12h. The refrigerant that has flowed to the external refrigerant circuit 20 flows through a heat exchanger or an expansion valve of the external refrigerant circuit 20. Then, the refrigerant flows through the suction port 13h and returns to the motor chamber S1. The motor-driven compressor 10 and the external refrigerant circuit 20 form a vehicle air conditioner 21.

The motor-driven compressor 10 includes an inverter cover 22. The inverter cover 22 is a part of the housing 11. Thus, the housing 11 includes an inverter cover 22. The inverter cover 22 has a tubular shape with one end closed. The inverter cover 22 has an open end that is coupled to the end wall 13a of the motor housing member 13. The end wall 13a of the motor housing member 13 and the inverter cover 22 define an inverter chamber 23. Thus, the housing 11 defines the inverter chamber 23. The end wall 13a of the motor housing member 13 serves as a partition wall that separates the motor chamber S1 from the inverter chamber 23.

The motor-driven compressor 10 includes an inverter 24. The inverter 24 is accommodated in the inverter chamber 23. Thus, the inverter chamber 23 accommodates the inverter 24. The inverter 24 drives the motor 16. The compression unit 15, the motor 16, and the inverter 24 are arranged in this order in the axial direction of the rotary shaft 14.

### Motor Wire

The motor-driven compressor 10 includes motor wires 25. The motor wires 25 are drawn out of the motor coil 19 of the motor 16. Specifically, three motor wires 25 are drawn out of the section of the motor coil 19 located closer to the end wall 13a of the motor housing member 13, corresponding to the U, V, and W phases of the motor coil 19. Each motor wire 25 is an electric wire that forms part of the motor coil 19. The electric wire is drawn out of the motor coil 19 while being coated with an insulating film.

### Through-Hole

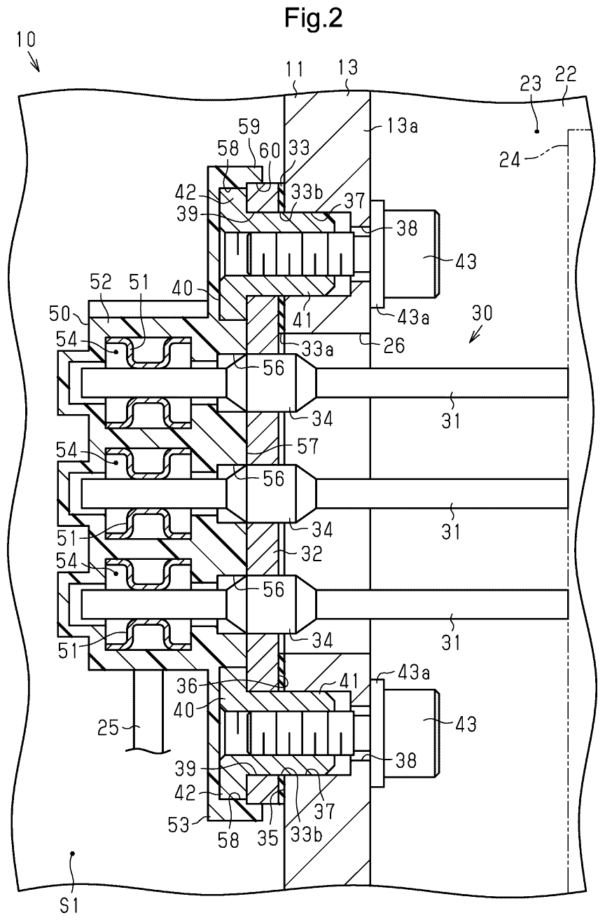

As shown in FIG. 2, the end wall 13a of the motor housing member 13 has a through-hole 26. The through-hole 26 extends through the end wall 13a of the motor housing member 13 in the thickness direction of the end wall 13a. The through-hole 26 is formed in the end wall 13a of the motor housing member 13 at a location outward from the center of the end wall 13a of the motor housing member 13 in the radial direction of the rotary shaft 14. A first end of the through-hole 26 opens in a first surface of the end wall 13a of the motor housing member 13. A second end of the through-hole 26 opens in a second surface of the end wall 13a of the motor housing member 13. The first surface of the end wall 13a faces the motor chamber S1. The second surface of the end wall 13a faces the inverter chamber 23. The first surface of the end wall 13a may be referred to as the partition wall opposing surface 35, which will be described later.

### Hermetic Terminal

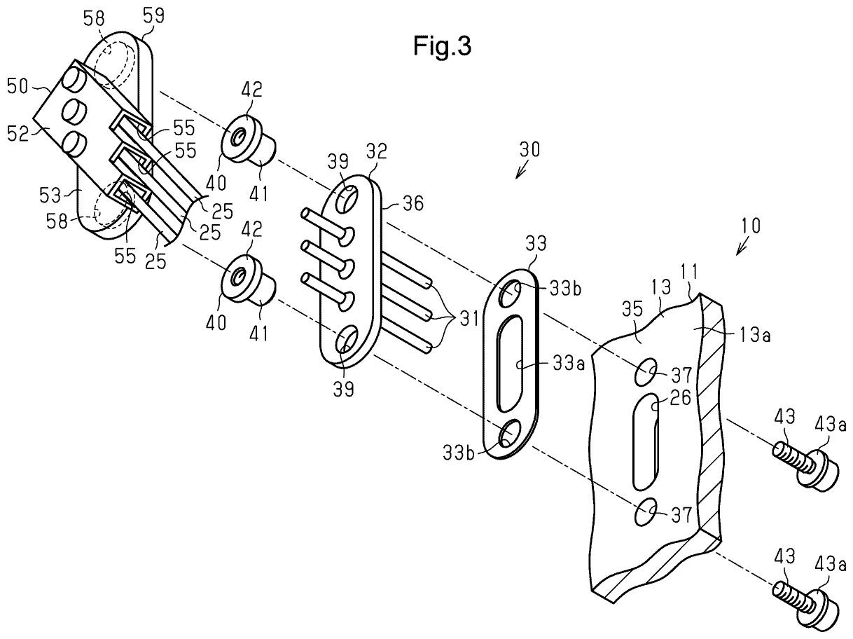

As shown in FIGS. 2 and 3, the motor-driven compressor 10 includes a hermetic terminal 30. The hermetic terminal 30 electrically connects the motor 16 to the inverter 24 while providing a seal between the motor chamber S1 and the inverter chamber 23.

The hermetic terminal 30 includes conductive members 31, a support plate 32, and a gasket 33. The hermetic terminal 30 includes three conductive members 31, corresponding to the U-phase, V-phase, and W-phase of the motor coil 19. Each conductive member 31 is a cylindrical metal pin extending straight. The conductive member 31 has a first end and a second end. The conductive member 31 passes through the through-hole 26. The conductive member 31 extends parallel to each other. The first end of the conductive member 31 protrudes into the inverter chamber 23 through the through-hole 26. The first end of the conductive member 31 is electrically connected to the inverter 24. The second end of the conductive member 31 protrudes into the motor chamber S1 through the through-hole 26.

The support plate 32 has the shape of a flat plate. The support plate 32 is made of metal. Each conductive member 31 extends through the support plate 32 in the thickness direction of the support plate 32. An insulating glass member 34 is disposed between each conductive member 31 and the support plate 32. Each glass member 34 insulates between the corresponding conductive member 31 and the support plate 32. The support plate 32 supports each conductive member 31, with the conductive member 31 insulated from the support plate 32 by the corresponding glass member 34.

The support plate 32 is fixed to the end wall 13a of the motor housing member 13 while being located in the motor chamber S1. The support plate 32 is fixed to the end wall 13a of the motor housing member 13 while closing the through-hole 26. The end wall 13a of the motor housing member 13 includes the partition wall opposing surface 35, which is opposed to the support plate 32. The partition wall opposing surface 35 is flat. The through-hole 26 opens in the partition wall opposing surface 35. The support plate 32 includes a plate opposing surface 36 that is opposed to the partition wall opposing surface 35. The plate opposing surface 36 is flat. The support plate 32 is located on the end wall 13a of the motor housing member 13, with the plate opposing surface 36 aligned along the partition wall opposing surface 35.

The gasket 33 has the shape of a flat plate. The gasket 33 is made of rubber that is elastically deformable. The gasket 33 is located between the partition wall opposing surface 35 and the plate opposing surface 36. The gasket 33 is in tight contact with the partition wall opposing surface 35 and the plate opposing surface 36. The gasket 33 provides a seal between the partition wall opposing surface 35 and the plate opposing surface 36.

The gasket 33 has a hole 33a. The hole 33a extends through the gasket 33 in the thickness direction of the gasket 33. The hole 33a has the same shape as the through-hole 26. The hole 33a is connected to the through-hole 26. The gasket 33 has two holes 33b. Each hole 33b extends through the gasket 33 in the thickness direction of the gasket 33. The two holes 33b are located on opposite sides of the hole 33a of the gasket 33. Each hole 33b is circular.

The end wall 13a of the motor housing member 13 has two wall holes 37. The two wall holes 37 are located on opposite sides of the through-hole 26 in the end wall 13a of the motor housing member 13. Each wall hole 37 is circular. Each wall hole 37 opens in the partition wall opposing surface 35. Each wall hole 37 is connected to the corresponding hole 33b of the gasket 33. The hole 37 has the same diameter as the hole 33b.

As shown in FIG. 2, the end wall 13a of the motor housing member 13 has two bolt insertion holes 38. Each bolt insertion hole 38 is connected to the end of the corresponding wall hole 37 opposite to the partition wall opposing surface 35. Each bolt insertion hole 38 opens in the second surface of the end wall 13a of the motor housing member 13. Each bolt insertion hole 38 is circular. The bolt insertion hole 38 has a smaller diameter than the wall hole 37.

The support plate 32 has two plate holes 39. Each plate hole 39 extends through the support plate 32 in the thickness direction of the support plate 32. The two plate holes 39 are located on opposite sides of the three conductive members 31 of the support plate 32. Each plate hole 39 is circular. Each plate hole 39 is connected to the corresponding hole 33b of the gasket 33. Each plate hole 39 is connected to the corresponding wall hole 37 through the corresponding hole 33b. The plate hole 39 has the same diameter as the hole 33b and the wall hole 37.

The hermetic terminal 30 includes two nuts 40. Each nut 40 includes a nut tubular portion 41 and a nut flange portion 42. The nut tubular portion 41 is cylindrical. The inner side of the nut tubular portion 41 defines an internal thread hole. The outer diameter of the nut tubular portion 41 is slightly smaller than the diameters of the wall hole 37, the hole 33b, and the plate hole 39. The nut tubular portion 41 can be sequentially inserted through the plate hole 39, the hole 33b, and the wall hole 37. Thus, the nut tubular portion 41 is inserted through the wall hole 37. In addition, the nut tubular portion 41 is inserted through the plate hole 39.

The nut flange portion 42 annularly protrudes outward in the radial direction of the nut tubular portion 41 from the nut tubular portion 41. The nut flange portion 42 protrudes from a part of the outer circumferential surface of the nut tubular portion 41 located at the end of the nut tubular portion 41 in the axial direction. Each nut 40 is arranged on the support plate 32, with the nut tubular portion 41 inserted through the corresponding plate hole 39 and the corresponding wall hole 37 and the nut flange portion 42 engaged with the periphery of the corresponding plate hole 39.

The hermetic terminal 30 includes two bolts 43. Each bolt 43 can be threadedly engaged with the nut tubular portion 41 of the nut 40. Each bolt 43 is integrated with a washer 43a. Each bolt 43 is threadedly engaged with the nut tubular portion 41 through the corresponding bolt insertion hole 38 from within the inverter chamber 23. Each bolt 43 fixes the support plate 32 to the end wall 13a of the motor housing member 13 via the nut flange portion 42 through a clamping force of the bolt 43 that occurs when the bolt 43 is threadedly engaged with the nut tubular portion 41 from within the inverter chamber 23.

### Cluster Block

The motor-driven compressor 10 includes a cluster block 50. The cluster block 50 is located in the motor chamber S1. The cluster block 50 is insulating. The cluster block 50 is made of resin. The cluster block 50 accommodates three connection terminals 51. Each connection terminal 51 electrically connects the hermetic terminal 30 to the motor wire 25. Thus, the cluster block 50 is located in the motor chamber S1, and accommodates the connection terminal 51, which electrically connects the hermetic terminal 30 to the motor wire 25.

The cluster block 50 includes a block body 52 and a block plate 53. The block body 52 has the shape of a substantially rectangular box. The block plate 53 has the shape of a flat plate. The block body 52 protrudes from a first surface of the block plate 53.

In the block body 52, three terminal accommodation chambers 54 are defined. Each terminal accommodation chamber 54 accommodates the corresponding connection terminal 51. As shown in FIG. 3, the block body 52 has three motor wire insertion holes 55. Each motor wire insertion hole 55 is connected to the corresponding terminal accommodation chamber 54. Each motor wire insertion hole 55 is configured to receive the corresponding motor wire 25. Each motor wire 25 is electrically connected to the connection terminal 51 in the terminal accommodation chamber 54 through the corresponding motor wire insertion hole 55.

As shown in FIG. 2, the block plate 53 has three conductive member insertion holes 56. Thus, the cluster block 50 has the conductive member insertion holes 56. Each conductive member insertion hole 56 opens in a second surface of the block plate 53, which is located opposite to the block body 52. Each conductive member insertion hole 56 is connected to the corresponding terminal accommodation chamber 54. Each conductive member insertion hole 56 is configured to receive the second end of the corresponding conductive member 31. The second end of each conductive member 31 is electrically connected to the connection terminal 51 in the terminal accommodation chamber 54 through the corresponding conductive member insertion hole 56. Thus, the second end of the conductive member 31 is inserted through the conductive member insertion hole 56. The conductive member 31 passes through the through-hole 26, with the first end electrically connected to the inverter 24 and the second end electrically connected to the connection terminal 51. The power from the inverter 24 is supplied to the motor 16 through the conductive member 31, the connection terminal 51, and the motor wire 25. Thus, the motor 16 is driven.

### Seal Surface

A second surface of the block plate 53 is flat. The second surface of the block plate 53 is configured to make surface contact with the support plate 32. The periphery of each conductive member insertion hole 56 in the second surface of the block plate 53 is a seal surface 57 that makes surface contact with the support plate 32. Thus, the periphery of the conductive member insertion hole 56 in the surface of the cluster block 50 opposed to the support plate 32 includes the seal surface 57, which makes surface contact with the support plate 32.

### Accommodation Portion

The block plate 53 has two accommodation portions 58. Thus, the cluster block 50 has the accommodation portions 58. Each accommodation portion 58 is located in the second surface of the block plate 53. The two accommodation portions 58 are arranged on the opposite sides of the three conductive member insertion holes 56. Each accommodation portion 58 is a recess having the shape of a circular hole in plan view. The diameter of each accommodation portion 58 is slightly larger than the outer diameter of the nut flange portion 42 of the corresponding nut 40. Each accommodation portion 58 accommodates the nut flange portion 42 of the corresponding nut 40.

### Annular Seal Portion

The block plate 53 includes an outer circumferential wall 59. The outer circumferential wall 59 protrudes in a tubular form from an outer circumferential portion of the second surface of the block plate 53. The cluster block 50 is located on the support plate 32, with the outer circumferential wall 59 surrounding the outer circumferential surface of the support plate 32. The inner circumferential surface of the outer circumferential wall 59 is in tight contact with the outer circumferential surface of the support plate 32. Thus, the inner circumferential surface of the outer circumferential wall 59 is an annular seal portion 60 that provides a seal between the inner circumferential surface of the outer circumferential wall 59 and the outer circumferential surface of the support plate 32 by surrounding the outer circumferential surface of the support plate 32. Thus, the cluster block 50 includes the annular seal portion 60.

### Operation of Embodiment

The operation of the present embodiment will now be described.

The periphery of each conductive member insertion hole 56 in the cluster block 50 includes the seal surface 57, which makes surface contact with the support plate 32. This limits situations in which foreign matter enters the cluster block 50 through the gap between the conductive member insertion hole 56 and the conductive member 31. Additionally, the annular seal portion 60 further limits situations in which foreign matter enters the cluster block 50 through the gap between the conductive member insertion hole 56 and the conductive member 31.

### Advantages of Embodiment

The above-described embodiment provides the following advantages.

(1) The support plate 32 is fixed to the end wall 13a while being located in the motor chamber S1, which receives the pressure of the refrigerant. Thus, since part of the support plate 32 is supported by the end wall 13a, the support plate 32 is less likely to be affected by the refrigerant pressure. Accordingly, the need of increasing the rigidity of the support plate 32 is eliminated by increasing the thickness of the support plate 32 such that the support plate 32 can withstand the refrigerant pressure. This eliminates the need of making additional space for the inverter 24 in the inverter chamber 23 such that the inverter 24 does not interfere with the support plate 32. As a result, an increase in the size of the motor-driven compressor 10 is avoided.

Further, the periphery of each conductive member insertion hole 56 in the cluster block 50 includes the seal surface 57, which makes surface contact with the support plate 32. This limits situations in which foreign matter enters the cluster block 50 through the gap between the conductive member insertion hole 56 and the conductive member 31. Thus, the periphery of the conductive member insertion hole 56 in the cluster block 50 serves as the seal surface 57, which makes surface contact with the support plate 32 fixed to the end wall 13a of the motor housing member 13 while being arranged in the motor chamber S1. Accordingly, the sealing performance of the cluster block 50, which is conventionally used in the motor chamber S1, is improved. For example, in a configuration in which a seal member is provided between the conductive member insertion hole 56 and the conductive member 31, this eliminates the need for maximizing the length of the seal member (i.e., the length of the conductive member insertion hole 56) to improve the sealing performance of the seal member. Hence, the size of the motor-driven compressor 10 is reduced.

(2) The hermetic terminal 30 includes the gasket 33, which has the shape of a flat plate and is located between the partition wall opposing surface 35 and the plate opposing surface 36. In this configuration, the support plate 32 is pressed against the partition wall opposing surface 35 by the pressure of the refrigerant. As a result, the gasket 33 is optimally compressed between the partition wall opposing surface 35 and the plate opposing surface 36. This improves the sealing performance between the partition wall opposing surface 35 and the plate opposing surface 36 with the gasket 33. Accordingly, the hermetic terminal 30 allows the motor 16 to be electrically connected to the inverter 24 while further providing a seal between the motor chamber S1 and the inverter chamber 23. This enhances the reliability of the motor-driven compressor 10.

(3) The support plate 32 is fixed to the end wall 13a of the motor housing member 13 using the bolt 43, with each nut tubular portion 41 inserted through the corresponding plate hole 39 and the corresponding wall hole 37. Thus, when fixing the support plate 32 to the end wall 13a of the motor housing member 13 using the bolt 43, the nut tubular portion 41 makes the relative position between the support plate 32 and the end wall 13a of the motor housing member 13 less likely to be shifted from each other. Accordingly, the position accuracy between the support plate 32 and the end wall 13a of the motor housing member 13 is ensured more easily. This allows the position of the conductive member 31 relative to the end wall 13a of the motor housing member 13 to be determined at the desired location more easily.

(4) The cluster block 50 has the accommodation portions 58, each accommodating the corresponding nut flange portion 42. Thus, the configuration in which the cluster block 50 has the accommodation portion 58, which accommodates the nut flange portion 42, optimally avoids interference between the cluster block 50 and the nut flange portion 42.

(5) The cluster block 50 includes the annular seal portion 60, which provides a seal between the cluster block 50 and the support plate 32 by surrounding the outer circumferential surface of the support plate 32. In this configuration, the annular seal portion 60 further limits situations in which foreign matter enters the cluster block 50 through the gap between the cluster block 50 and the support plate 32.

The annular seal portion 60 surrounds the outer circumferential surface of the support plate 32. Thus, the cluster block 50 is brought closer to the end wall 13a of the motor housing member 13 by an amount in which the annular seal portion 60 surrounds the outer circumferential surface of the support plate 32. This allows the cluster block 50 to be located in the motor chamber S1 as close as possible to the end wall 13a of the motor housing member 13. Accordingly, the size of the motor-driven compressor 10 is further reduced. This improves the sealing performance of the cluster block 50 while further reducing the size of the motor-driven compressor 10.

### Modifications

The above-described embodiment may be modified as follows. The above-described embodiment and the following modifications can be combined if the combined modifications remain technically consistent with each other.

In the embodiment, the cluster block 50 does not have to include the annular seal portion 60.

In the embodiment, the accommodation portion 58, which accommodates the nut flange portion 42, may be located in, for example, the support plate 32. In this case, the accommodation portion 58 is a circular recess that is connected to the plate hole 39 and is larger than the plate hole 39.

In the embodiment, the accommodation portion 58 is not limited to a recess, and may be, for example, a hole that extends through the block plate 53 in the thickness direction of the block plate 53. That is, the accommodation portion 58 only needs to accommodate the nut flange portion 42.

In the embodiment, the cluster block 50 may be integrally molded with a resin component that is a part of the motor 16. Examples of the resin component include a resin cover that insulates between the motor coil 19 and the housing 11.

In the embodiment, the end wall 13a of the motor housing member 13 may have, for instance, an internal thread hole. In this case, the support plate 32 may be fixed to the end wall 13a of the motor housing member 13 by threading a bolt into the internal thread hole through the plate hole 39 from the motor chamber S1.

In the embodiment, for example, the closed end of the inverter cover 22 may be connected to the end wall 13a of the motor housing member 13, and the open end of the inverter cover 22 may be closed by a lid member that is separate from the motor housing member 13. The inverter chamber 23 may be defined by the inverter cover 22 and the lid member. In this case, the end wall 13a of the motor housing member 13 and the bottom wall of the inverter cover 22 serve as a partition wall that separates the motor chamber S1 from the inverter chamber 23.

In the embodiment, in the motor-driven compressor 10, for example, the inverter 24 may be located outward from the housing 11 in the radial direction of the rotary shaft 14. That is, the compression unit 15, the motor 16, and the inverter 24 do not have to be arranged in this order in the axial direction of the rotary shaft 14.

In the embodiment, the compression unit 15 is not limited to a scroll type. Instead, the compression unit 15 may be, for example, a piston type, a vane type, or a rotary type.

In the embodiment, the motor-driven compressor 10 is for use with the vehicle air conditioner 21. Instead, for example, the motor-driven compressor 10 may be installed in a fuel cell electric vehicle and may compress air, which is fluid supplied to the fuel cell, with the compression unit 15.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A motor-driven compressor, comprising:
a compression unit configured to compress fluid;
a motor configured to drive the compression unit;
an inverter configured to drive the motor;
a housing that defines a motor chamber which accommodates the motor and into which fluid is drawn, and defines an inverter chamber that accommodates the inverter, the housing including a partition wall that separates the motor chamber from the inverter chamber;
a hermetic terminal that electrically connects the motor to the inverter while providing a seal between the motor chamber and the inverter chamber;
a connection terminal that electrically connects the hermetic terminal to a motor wire drawn out of the motor; and
an insulating cluster block located in the motor chamber, the cluster block accommodating the connection terminal, wherein
the partition wall includes a through-hole,
the hermetic terminal includes:
a conductive member that passes through the through-hole, the conductive member having a first end electrically connected to the inverter and a second end electrically connected to the connection terminal; and
a support plate fixed to the partition wall while supporting the conductive member and blocking the through-hole,
the cluster block includes a conductive member insertion hole through which the second end of the conductive member is inserted,
the support plate is fixed to the partition wall while being arranged in the motor chamber, and
a periphery of the conductive member insertion hole in the cluster block includes a seal surface that makes surface contact with the support plate.

2. The motor-driven compressor according to claim 1, wherein
the partition wall includes a partition wall opposing surface opposed to the support plate,
the support plate includes a plate opposing surface opposed to the partition wall opposing surface, and
the hermetic terminal further includes a gasket having a shape of a flat plate, the gasket being located between the partition wall opposing surface and the plate opposing surface.

3. The motor-driven compressor according to claim 1, wherein
the hermetic terminal includes:
a nut that includes a nut tubular portion and a nut flange portion that annularly protrudes outward in a radial direction of the nut tubular portion from the nut tubular portion; and
a bolt configured to be threadedly engaged with the nut tubular portion, the partition wall further includes a wall hole through which the nut tubular portion is inserted,
the support plate further includes a plate hole through which the nut tubular portion is inserted, the plate hole being connected to the wall hole,
the nut is arranged on the support plate, with the nut tubular portion inserted through the plate hole and the wall hole and the nut flange portion engaged with a periphery of the plate hole, and
the bolt fixes the support plate to the partition wall via the nut flange portion through a clamping force of the bolt that occurs when the bolt is threadedly engaged with the nut tubular portion from within the inverter chamber.

4. The motor-driven compressor according to claim 3, wherein
the cluster block further includes an accommodation portion that accommodates the nut flange portion.

5. The motor-driven compressor according to claim 1, wherein
the cluster block further includes an annular seal portion configured to provide a seal between the cluster block and the support plate by surrounding an outer circumferential surface of the support plate.
